(19) United States
(12) Patent Application Publication
(10) Pub. No.: US 2026/0241545 A1
(43) Pub. Date: Aug. 20, 2026

(54) FIVE-DEGREE-OF-FREEDOM HYBRID ROBOT

(71) Applicants: Tianjin University, Tianjin (CN); Nanjing University of Science and Technology, Nanjing (CN); Ruilian Intelligent Control (Tianjin) Technology Co., Ltd., Tianjin (CN)

(72) Inventors: Haitao LIU, Tianjin (CN); Zhankui ZHANG, Tianjin (CN); Manxin WANG, Nanjing (CN); Chunhai SHI, Tianjin (CN); Jiangping MEI, Tianjin (CN); Xianlei SHAN, Tianjin (CN); Juliang XIAO, Tianjin (CN); Tian HUANG, Tianjin (CN); Hao LI, Tianjin (CN); Zhongchen CAO, Tianjin (CN); Jianbin LIU, Tianjin (CN); Yunpeng LIU, Tianjin (CN)

(21) Appl. No.: 19/458,670

(22) Filed: Jan. 23, 2026

(30) Foreign Application Priority Data
Feb. 20, 2025 (CN) 202510186751.5

(51) Int. Cl. B25J 9/00; B25J 9/10; B25J 17/02

(52) U.S. Cl. CPC B25J 9/0009; B25J 9/1065; B25J 17/0266

(57) ABSTRACT

A five-degree-of-freedom hybrid robot including: a first pair of fixed supports and a second pair of fixed supports; a first rotating frame, a second rotating frame, and a third rotating frame; a rotation constraint mechanism; a first actuated limb, a second actuated limb, and a third actuated limb; a moving platform; and a two-degree-of-freedom wrist. The first pair of fixed supports and the second pair of fixed supports are arranged mutually parallel and symmetrically with each other. The first rotating frame is rotatably disposed between two laterally opposed members of the first pair fixed supports. The second rotating frame is rotatably disposed between two laterally opposed members of the second pair fixed supports. The third rotating frame is rotatably connected to the second rotating frame via an inter-frame revolute joint. The first actuated limb and the second actuated limb are symmetrically disposed on the first rotating frame.

### CROSS-REFERENCE TO RELATED APPLICATIONS

Pursuant to 35 U.S.C. § 119 and the Paris Convention Treaty, this application claims foreign priority to Chinese Patent Application No. CN 202510186751.5 filed Feb. 20, 2025, the contents of which, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to the field of robotics technology, and more particularly, to a five-degree-of-freedom (DOF) hybrid robot.

Hybrid robots exhibit high flexibility, high stiffness, and a large workspace, offering significant benefits for machining structural components with complex curved surfaces. Consequently, they are widely used in fields such as aerospace, rail transportation, automotive, and shipbuilding.

Existing five-degree-of-freedom hybrid robots include a parallel mechanism and a two-DOF wrist. The parallel mechanism includes a base platform, a rotating frame, a moving platform, the two-DOF wrist, and three actuated limbs. The rotating frame is hinged to the base platform via revolute joints. The first and second actuated limbs are arranged symmetrically in space relative to the third actuated limb. One end of each of the first and second actuated limbs is connected to the rotating frame via a revolute joint, and the other end is connected to the moving platform via a revolute joint. One end of the third actuated limb is connected to the base platform via a spherical joint formed by three composite revolute joints, while the other end is connected to the moving platform via a revolute joint.

In such hybrid robots, only the first and second actuated limbs can adopt identical structures. To realize the spherical joint at the base platform, the third actuated limb must additionally provide a rotational degree-of-freedom about its own prismatic direction, and the axis of this rotation must intersect at a single point with the two rotational axes of the rotating frame to which the third actuated limb is attached. This results in a complex structure and imposes stringent requirements on machining and assembly.

The parallel portion of this hybrid robot is a three-DOF parallel mechanism providing one translation and two rotations, so that the moving platform possesses two rotational degrees of freedom. However, the orientation of the end of the third actuated limb is determined by the coupled motion of the three revolute joints constituting the spherical joint. Moreover, because the third actuated limb differs structurally from the first and second actuated limbs, the kinematic analysis becomes relatively complicated.

### SUMMARY

One object of the disclosure is to provide a five-degree-of-freedom (DOF) hybrid robot comprising: a first pair of fixed supports and a second pair of fixed supports; a first rotating frame, a second rotating frame, and a third rotating frame; a rotation constraint mechanism; a first actuated limb, a second actuated limb, and a third actuated limb; a moving platform; and a two-degree-of-freedom wrist serially connected to the moving platform.

The first pair of fixed supports and the second pair of fixed supports are arranged mutually parallel and symmetrically with each other; the first rotating frame is rotatably disposed between two laterally opposed members of the first pair fixed supports; the second rotating frame is rotatably disposed between two laterally opposed members of the second pair fixed supports; the third rotating frame is rotatably connected to the second rotating frame via an inter-frame revolute joint; the first actuated limb and the second actuated limb are symmetrically disposed on the first rotating frame; one end of each of the first actuated limb and the second actuated limb is rotatably connected to the first rotating frame, and the other end thereof is rotatably connected to the moving platform; the first actuated limb and the second actuated limb lie in a common horizontal plane; one end of the third actuated limb is rotatably connected to the third rotating frame, and the other end thereof is rotatably connected to the moving platform; and the rotation constraint mechanism is disposed between the first rotating frame and the second rotating frame, and is configured such that an axis of the inter-frame revolute joint remains perpendicular to the common horizontal plane in which the first actuated limb and the second actuated limb lie.

In a class of this embodiment, the rotation constraint mechanism comprises a connecting link, one end of the connecting link being rotatably connected to the first rotating frame and the other end being rotatably connected to the second rotating frame, thereby forming, together with the first rotating frame and the second rotating frame, a composite frame structure based on a parallelogram mechanism that constrains relative rotation between the first rotating frame and the second rotating frame.

In a class of this embodiment, the first actuated limb comprises a first lug and a first prismatic slide; the second actuated limb comprises a second lug and a second prismatic slide; and the third actuated limb comprises a third lug and a third prismatic slide; the first rotating frame is connected to the first lug to form a first revolute joint of actuated limbs; the first lug is connected to the first prismatic slide to form a first prismatic joint; a front end of the first prismatic slide is connected to the moving platform to form a second revolute joint of actuated limbs; the first rotating frame is connected to the second lug to form a third revolute joint of actuated limbs; the second lug is connected to the second prismatic slide to form a second prismatic joint; a front end of the second prismatic slide is connected to the moving platform to form a fourth revolute joint of actuated limbs; the third rotating frame is connected to the third lug to form a fifth revolute joint of actuated limbs; the third lug is connected to the third prismatic slide to form a third prismatic joint; a front end of the third prismatic slide is connected to the moving platform to form a sixth revolute joint of actuated limbs.

In a class of this embodiment, an axis of the first revolute joint of actuated limbs, an axis of the second revolute joint of actuated limbs, an axis of the third revolute joint of actuated limbs, and an axis of the fourth revolute joint of actuated limbs are mutually parallel; an axis of the first prismatic joint perpendicularly intersects both the axis of the first revolute joint of actuated limbs and the axis of the second revolute joint of actuated limbs; an axis of the second prismatic joint perpendicularly intersects both the axis of the third revolute joint of actuated limbs and the axis of the fourth revolute joint of actuated limbs; an axis of the first rotating frame, the axis of the first revolute joint of actuated limbs, and the axis of the first prismatic joint intersect at a single point; the axis of the first rotating frame, the axis of the third revolute joint of actuated limbs, and the axis of the second prismatic joint intersect at another single point; the axis of the first rotating frame perpendicularly intersects both the axis of the first revolute joint of actuated limbs and the axis of the third revolute joint of actuated limbs.

In a class of this embodiment, the axis of the first prismatic joint and the axis of the second prismatic joint define the common horizontal plane; an axis of the fifth revolute joint of actuated limbs and an axis of the sixth revolute joint of actuated limbs are parallel to each other; an axis of the third prismatic joint perpendicularly intersects both the axis of the fifth revolute joint of actuated limbs and the axis of the sixth revolute joint of actuated limbs; an axis of the inter-frame revolute joint intersects both the axis of the fifth revolute joint of actuated limbs and the axis of the third prismatic joint at a single point, and is perpendicular to the axis of the fifth revolute joint of actuated limbs; and the axis of the sixth revolute joint of actuated limbs perpendicularly intersects both the axis of the second revolute joint of actuated limbs and the axis of the fourth revolute joint of actuated limbs.

In a class of this embodiment, opposite ends of the first rotating frame are rotatably connected to respective members of the first pair of fixed supports, thereby forming a first revolute joint of rotating frames; opposite ends of the second rotating frame are rotatably connected to respective members of the second pair of fixed supports, thereby forming a second revolute joint of rotating frames; the first rotating frame is rotatably connected to one end of the connecting link, thereby forming a third revolute joint of rotating frames; the second rotating frame is rotatably connected to the other end of the connecting link, thereby forming a fourth revolute joint of rotating frames.

In a class of this embodiment, an axis of the first revolute joint of rotating frames, an axis of the second revolute joint of rotating frames, an axis of the third revolute joint of rotating frames, and an axis of the fourth revolute joint of rotating frames are mutually parallel; a distance between the axis of the first revolute joint of rotating frames and the axis of the second revolute joint of rotating frames is equal to a distance between the axis of the third revolute joint of rotating frames and the axis of the fourth revolute joint of rotating frames; a distance between the axis of the first revolute joint of rotating frames and the axis of the third revolute joint of rotating frames is equal to a distance between the axis of the second revolute joint of rotating frames and the axis of the fourth revolute joint of rotating frames; the first rotating frame, the connecting link, and the second rotating frame together constitute a composite frame structure based on the principle of a parallelogram mechanism, thereby ensuring that an axis of the inter-frame revolute joint remains parallel to the axis of the first revolute joint of actuated limbs and the axis of the third revolute joint of actuated limbs.

In a class of this embodiment, the two-degree-of-freedom wrist comprises a first wrist joint and a second wrist joint; the first wrist joint is connected to the moving platform to form the wrist's first revolute joint; the second wrist joint is connected to the first wrist joint to form the wrist's second revolute joint; the axis of the wrist's first revolute joint is perpendicular to the plane defined by the axis of the second revolute joint of actuated limbs and the axis of the fourth revolute joint of actuated limbs ; and the axis of the wrist's second revolute joint is parallel to the plane.

In a class of this embodiment, the first prismatic joint, the second prismatic joint, and the third prismatic joint are actuated joints.

The following advantages are associated with the five-degree-of-freedom hybrid robot of the disclosure.

The hybrid robot exhibits a highly modular characteristic. By employing a rotation constraint mechanism, particularly a composite frame structure based on the principle of a parallelogram mechanism, kinematic decoupling of the end-effector posture of the third actuated limb is achieved, resulting in clear motion patterns and facilitating control.

The first, second, and third actuated limbs of the disclosure have completely identical structures, providing excellent interchangeability, simplifying structural design, and reducing manufacturing costs.

The parallel portion of the disclosure is a three-degree-of-freedom parallel mechanism providing one translation and two rotations. A two-degree-of-freedom wrist is serially connected to the end of the moving platform, thereby constituting a five-degree-of-freedom hybrid robot. The three actuated limbs of this robot share the same structure, resulting in an equipment system with a high degree of modularity, easily guaranteed manufacturing and assembly accuracy, high stiffness, clear motion patterns, and ease of control.

### BRIEF DESCRIPTION OF THE DRAWINGS

FIG. 1 is a schematic diagram of a five-degree-of-freedom hybrid robot of the disclosure;

FIG. 2 is a schematic diagram of revolute joints of a five-degree-of-freedom hybrid robot of the disclosure;

FIG. 3 is a principle diagram of a rotation constraint mechanism of the disclosure;

FIG. 4 is a side view of FIG. 3;

FIG. 5 is a schematic diagram showing a first actuated limb, a second actuated limb, and related connections thereof of the disclosure; and

FIG. 6 is a schematic diagram of a third actuated limb and related connections thereof of the disclosure.

1. First pair of fixed supports; 2. Second pair of fixed supports; 3. First rotating frame; 4. Second rotating frame; 5. Third rotating frame; 6. Rotation constraint mechanism; 6a. Connecting link; 7. First actuated limb; 7a. First lug; 7b. First prismatic slide; 8. Second actuated limb; 8a. Second lug; 8b. Second prismatic slide; 9. Third actuated limb; 9a. Third lug; 9b. Third prismatic slide; 10. Moving platform; 11. Two-degree-of-freedom wrist; 11a. First wrist joint; 11b. Second wrist joint; 1-1. First revolute joint of rotating frames ; 1-2. Second revolute joint of rotating frames ; 1-3. Third revolute joint of rotating frames ; 1-4. Fourth revolute joint of rotating frames ; 1-5. Inter-frame revolute joint; 2-1. First revolute joint of actuated limbs ; 2-2. Second revolute joint of actuated limbs ; 2-3. Third revolute joint of actuated limbs ; 2-4. Fourth revolute joint of actuated limbs ; 2-5. Fifth revolute joint of actuated limbs ; 2-6. Sixth revolute joint of actuated limbs ; 3-1. First prismatic joint; 3-2. Second prismatic joint; 3-3. Third prismatic joint; 4-1. Wrist's first revolute joint; 4-2. Wrist's second revolute joint.

### DETAILED DESCRIPTION

To further illustrate the disclosure, embodiments detailing a five-degree-of-freedom hybrid robot are described below. It should be noted that the following embodiments are intended to describe and not to limit the disclosure.

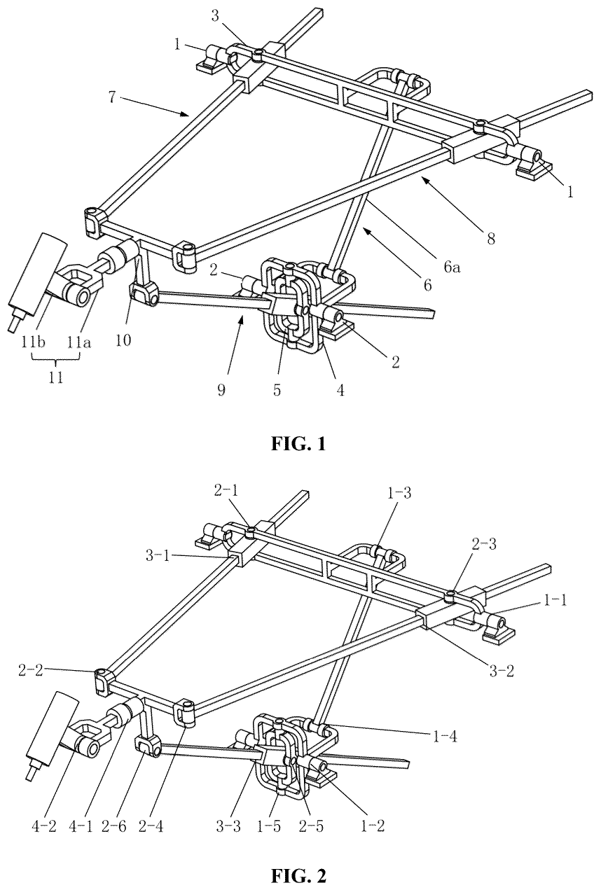

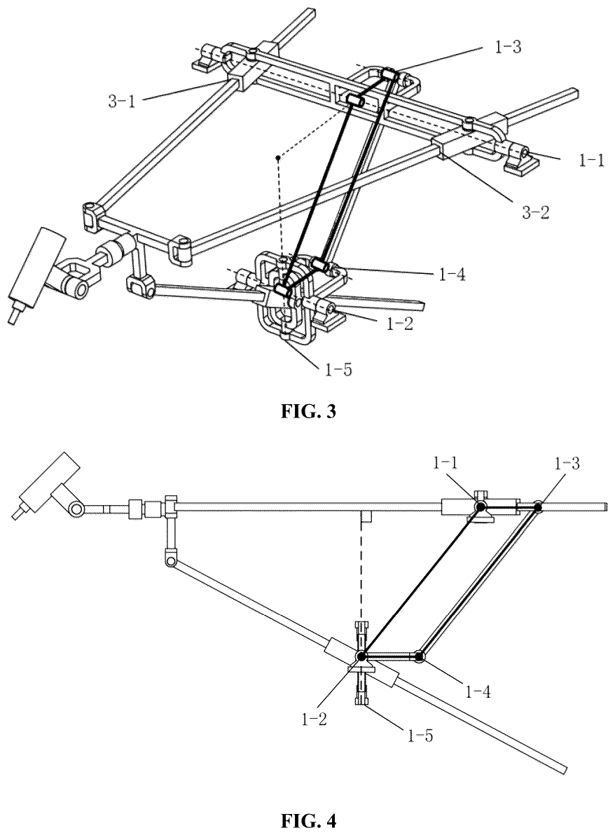

As shown in FIGS. 1 and 2, a five-degree-of-freedom (DOF) hybrid robot comprises: a first pair fixed supports 1, a second pair of fixed supports 2, a first rotating frame 3, a second rotating frame 4, a third rotating frame 5, a rotation constraint mechanism 6, a first actuated limb 7, a second actuated limb 8, a third actuated limb 9, a moving platform 10, and a two-DOF wrist 11 serially connected to the moving platform 10. The first pair fixed supports 1 and the second pair fixed supports 2 are arranged mutually parallel and symmetrically with each other. The first rotating frame 3 is rotatably disposed between the two laterally opposed members of the first pair fixed supports 1. The second rotating frame 4 is rotatably disposed between the two laterally opposed members of the second pair fixed supports 2. The third rotating frame 5 is rotatably connected to the second rotating frame 4 via an inter-frame revolute joint 1-5. Herein, the term “inter-frame revolute joint” refers to a pivotal connection between the second rotating frame 4 and the third rotating frame 5, as shown in FIGS. 3 and 4. The first actuated limb 7 and the second actuated limb 8 are symmetrically disposed on the first rotating frame 3. One end of each of the first actuated limb 7 and the second actuated limb 8 is rotatably connected to the first rotating frame 3, and the other end thereof is rotatably connected to the moving platform 10. Furthermore, the first actuated limb 7 and the second actuated limb 8 are disposed in a common horizontal plane. One end of the third actuated limb 9 is rotatably connected to the third rotating frame 5, and the other end thereof is rotatably connected to the moving platform 10.

The rotation constraint mechanism 6 is disposed between the first rotating frame 3 and the second rotating frame 4. The rotation constraint mechanism 6 is configured such that the axis of the inter-frame revolute joint 1-5 remains perpendicular to the common horizontal plane in which the first actuated limb 7 and the second actuated limb 8 lie.

In a preferred embodiment, as shown in FIGS. 1, 3 and 4, the rotation constraint mechanism 6 comprises a connecting link 6a. One end of the connecting link 6a is rotatably connected to the first rotating frame 3, and the other end is rotatably connected to the second rotating frame 4. Together, they form a composite frame structure based on the principle of a parallelogram mechanism, which constrains the relative rotation between the first rotating frame 3 and the second rotating frame 4.

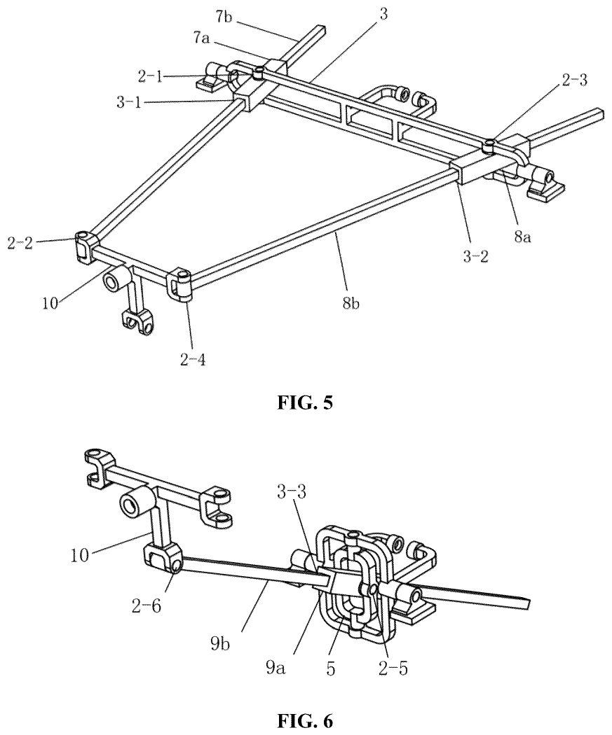

In a preferred embodiment, as shown in FIGS. 5 and 6, the first actuated limb 7 comprises a first lug 7a and a first prismatic slide 7b. The second actuated limb 8 comprises a second lug 8a and a second prismatic slide 8b. The third actuated limb 9 comprises a third lug 9a and a third prismatic slide 9b.

The first rotating frame 3 is connected to the first lug 7a to form the first revolute joint 2-1 of actuated limbs. The first lug 7a is connected to the first prismatic slide 7b to form the first prismatic joint 3-1. The front end of the first prismatic slide 7b is connected to the moving platform 10 to form the second revolute joint 2-2 of actuated limbs. The first rotating frame 3 is connected to the second lug 8a to form the third revolute joint 2-3 of actuated limbs. The second lug 8a is connected to the second prismatic slide 8b to form the second prismatic joint 3-2. The front end of the second prismatic slide 8b is connected to the moving platform 10 to form the fourth revolute joint 2-4 of actuated limbs. The third rotating frame 5 is connected to the third lug 9a to form the fifth revolute joint 2-5 of actuated limbs. The third lug 9a is connected to the third prismatic slide 9b to form the third prismatic joint 3-3. The front end of the third prismatic slide 9b is connected to the moving platform 10 to form the sixth revolute joint 2-6 of actuated limbs.

The axis of the first revolute joint 2-1 of actuated limbs, the axis of the second revolute joint 2-2 of actuated limbs, the axis of the third revolute joint 2-3 of actuated limbs, and the axis of the fourth revolute joint 2-4 of actuated limbs are mutually parallel. The axis of the first prismatic joint 3-1 perpendicularly intersects both the axis of the first revolute joint 2-1 of actuated limbs and the axis of the second revolute joint 2-2 of actuated limbs. The axis of the second prismatic joint 3-2 perpendicularly intersects both the axis of the third revolute joint 2-3 of actuated limbs and the axis of the fourth revolute joint 2-4 of actuated limbs. The axis of the first rotating frame 3, the axis of the first revolute joint 2-1 of actuated limbs, and the axis of the first prismatic joint 3-1 intersect at a single point. The axis of the first rotating frame 3, the axis of the third revolute joint 2-3 of actuated limbs, and the axis of the second prismatic joint 3-2 intersect at another single point. The axis of the first rotating frame 3 perpendicularly intersects both the axis of the first revolute joint 2-1 of actuated limbs and the axis of the third revolute joint 2-3 of actuated limbs.

The axis of the first prismatic joint 3-1 and the axis of the second prismatic joint 3-2 define the common horizontal plane, referred to herein as plane A.

The axis of the fifth revolute joint 2-5 of actuated limbs and the axis of the sixth revolute joint 2-6 of actuated limbs are parallel to each other. The axis of the third prismatic joint 3-3 perpendicularly intersects both the axis of the fifth revolute joint 2-5 of actuated limbs and the axis of the sixth revolute joint 2-6 of actuated limbs. The axis of the inter-frame revolute joint 1-5 intersects both the axis of the fifth revolute joint 2-5 of actuated limbs and the axis of the third prismatic joint 3-3 at a single point, and is perpendicular to the axis of the fifth revolute joint 2-5 of actuated limbs.

The axis of the sixth revolute joint 2-6 of actuated limbs perpendicularly intersects both the axis of the second revolute joint 2-2 of actuated limbs and the axis of the fourth revolute joint 2-4 of actuated limbs.

In a preferred embodiment, as shown in FIGS. 1 to 4, opposite ends of the first rotating frame 3 are rotatably connected to the respective members of the first pair of fixed supports 1, thereby forming the first revolute joint 1-1 of rotating frames. The opposite ends of the second rotating frame 4 are rotatably connected to the respective members of the second pair of fixed supports 2, thereby forming the second revolute joint 1-2 of rotating frames. The first rotating frame 3 is rotatably connected to one end of the connecting link 6a, thereby forming the third revolute joint 1-3 of rotating frames. The second rotating frame 4 is rotatably connected to the other end of the connecting link 6a, thereby forming the fourth revolute joint 1-4 of rotating frames.

The axis of the first revolute joint 1-1 of rotating frames, the axis of the second revolute joint 1-2 of rotating frames, the axis of the third revolute joint 1-3 of rotating frames, and the axis of the fourth revolute joint 1-4 of rotating frames are mutually parallel. The distance between the axis of the first revolute joint 1-1 of rotating frames and the axis of the second revolute joint 1-2 of rotating frames is equal to the distance between the axis of the third revolute joint 1-3 of rotating frames and the axis of the fourth revolute joint 1-4 of rotating frames. The distance between the axis of the first revolute joint 1-1 of rotating frames and the axis of the third revolute joint 1-3 of rotating frames is equal to the distance between the axis of the second revolute joint 1-2 of rotating frames and the axis of the fourth revolute joint 1-4 of rotating frames. The first rotating frame 3, the connecting link 6a, and the second rotating frame 4 together constitute a composite frame structure based on the principle of a parallelogram mechanism. This structure ensures that the axis of the inter-frame revolute joint 1-5 remains parallel to the axis of the first revolute joint 2-1 of actuated limbs and the axis of the third revolute joint 2-3 of actuated limbs; i.e., the axis of the inter-frame revolute joint 1-5 remains perpendicular to the plane A.

In a preferred embodiment, as shown in FIGS. 1 and 2, the two-degree-of-freedom wrist 11 comprises a first wrist joint 11a and a second wrist joint 11b. The first wrist joint 11a is connected to the moving platform 10 to form the wrist's first revolute joint 4-1. The second wrist joint 11b is connected to the first wrist joint 11a to form the wrist's second revolute joint 4-2. The axis of the wrist's first revolute joint 4-1 is perpendicular to the plane defined by the axis of the second revolute joint 2-2 of actuated limbs and the axis of the fourth revolute joint 2-4 of actuated limbs. The axis of the wrist's second revolute joint 4-2 is parallel to the plane.

Preferably, the first prismatic joint 3-1, the second prismatic joint 3-2, and the third prismatic joint 3-3 are actuated joints.

It will be obvious to those skilled in the art that changes and modifications may be made, and therefore, the aim in the appended claims is to cover all such changes and modifications.

What is claimed is:

1. A five-degree-of-freedom hybrid robot, comprising:
a first pair of fixed supports and a second pair of fixed supports;
a first rotating frame, a second rotating frame, and a third rotating frame;
a rotation constraint mechanism;
a first actuated limb, a second actuated limb, and a third actuated limb;
a moving platform; and
a two-degree-of-freedom wrist serially connected to the moving platform;
wherein:
the first pair of fixed supports and the second pair of fixed supports are arranged mutually parallel and symmetrically with each other;
the first rotating frame is rotatably disposed between two laterally opposed members of the first pair fixed supports;
the second rotating frame is rotatably disposed between two laterally opposed members of the second pair fixed supports;
the third rotating frame is rotatably connected to the second rotating frame via an inter-frame revolute joint;
the first actuated limb and the second actuated limb are symmetrically disposed on the first rotating frame;
one end of each of the first actuated limb and the second actuated limb is rotatably connected to the first rotating frame, and the other end thereof is rotatably connected to the moving platform;
the first actuated limb and the second actuated limb lie in a common horizontal plane;
one end of the third actuated limb is rotatably connected to the third rotating frame, and the other end thereof is rotatably connected to the moving platform; and
the rotation constraint mechanism is disposed between the first rotating frame and the second rotating frame, and is configured such that an axis of the inter-frame revolute joint remains perpendicular to the common horizontal plane in which the first actuated limb and the second actuated limb lie.

2. The robot of claim 1, wherein the rotation constraint mechanism comprises a connecting link, one end of the connecting link being rotatably connected to the first rotating frame and the other end being rotatably connected to the second rotating frame, thereby forming, together with the first rotating frame and the second rotating frame, a composite frame structure based on a parallelogram mechanism that constrains relative rotation between the first rotating frame and the second rotating frame.

3. The robot of claim 1, wherein
the first actuated limb comprises a first lug and a first prismatic slide; the second actuated limb comprises a second lug and a second prismatic slide; and the third actuated limb comprises a third lug and a third prismatic slide;
the first rotating frame is connected to the first lug to form a first revolute joint of actuated limbs; the first lug is connected to the first prismatic slide to form a first prismatic joint; a front end of the first prismatic slide is connected to the moving platform to form a second revolute joint of actuated limbs; the first rotating frame is connected to the second lug to form a third revolute joint of actuated limbs; the second lug is connected to the second prismatic slide to form a second prismatic joint; a front end of the second prismatic slide is connected to the moving platform to form a fourth revolute joint of actuated limbs; the third rotating frame is connected to the third lug to form a fifth revolute joint of actuated limbs; the third lug is connected to the third prismatic slide to form a third prismatic joint; a front end of the third prismatic slide is connected to the moving platform to form a sixth revolute joint of actuated limbs;
an axis of the first revolute joint of actuated limbs, an axis of the second revolute joint of actuated limbs, an axis of the third revolute joint of actuated limbs, and an axis of the fourth revolute joint of actuated limbs are mutually parallel; an axis of the first prismatic joint perpendicularly intersects both the axis of the first revolute joint of actuated limbs and the axis of the second revolute joint of actuated limbs; an axis of the second prismatic joint perpendicularly intersects both the axis of the third revolute joint of actuated limbs and the axis of the fourth revolute joint of actuated limbs; an axis of the first rotating frame, the axis of the first revolute joint of actuated limbs, and the axis of the first prismatic joint intersect at a single point; the axis of the first rotating frame, the axis of the third revolute joint of actuated limbs, and the axis of the second prismatic joint intersect at another single point; the axis of the first rotating frame perpendicularly intersects both the axis of the first revolute joint of actuated limbs and the axis of the third revolute joint of actuated limbs;
the axis of the first prismatic joint and the axis of the second prismatic joint define the common horizontal plane;
an axis of the fifth revolute joint of actuated limbs and an axis of the sixth revolute joint of actuated limbs are parallel to each other; an axis of the third prismatic joint perpendicularly intersects both the axis of the fifth revolute joint of actuated limbs and the axis of the sixth revolute joint of actuated limbs; an axis of the inter-frame revolute joint intersects both the axis of the fifth revolute joint of actuated limbs and the axis of the third prismatic joint at a single point, and is perpendicular to the axis of the fifth revolute joint of actuated limbs; and
the axis of the sixth revolute joint of actuated limbs perpendicularly intersects both the axis of the second revolute joint of actuated limbs and the axis of the fourth revolute joint of actuated limbs.

4. The robot of claim 3, wherein
opposite ends of the first rotating frame are rotatably connected to respective members of the first pair of fixed supports, thereby forming a first revolute joint of rotating frames; opposite ends of the second rotating frame are rotatably connected to respective members of the second pair of fixed supports, thereby forming a second revolute joint of rotating frames; the first rotating frame is rotatably connected to one end of the connecting link, thereby forming a third revolute joint of rotating frames; the second rotating frame is rotatably connected to the other end of the connecting link, thereby forming a fourth revolute joint of rotating frames; and
an axis of the first revolute joint of rotating frames, an axis of the second revolute joint of rotating frames, an axis of the third revolute joint of rotating frames, and an axis of the fourth revolute joint of rotating frames are mutually parallel; a distance between the axis of the first revolute joint of rotating frames and the axis of the second revolute joint of rotating frames is equal to a distance between the axis of the third revolute joint of rotating frames and the axis of the fourth revolute joint of rotating frames; a distance between the axis of the first revolute joint of rotating frames and the axis of the third revolute joint of rotating frames is equal to a distance between the axis of the second revolute joint of rotating frames and the axis of the fourth revolute joint of rotating frames; the first rotating frame, the connecting link, and the second rotating frame together constitute a composite frame structure based on the principle of a parallelogram mechanism, thereby ensuring that an axis of the inter-frame revolute joint remains parallel to the axis of the first revolute joint of actuated limbs and the axis of the third revolute joint of actuated limbs.

5. The robot of claim 3, wherein the two-degree-of-freedom wrist comprises a first wrist joint and a second wrist joint; the first wrist joint is connected to the moving platform to form the wrist's first revolute joint; the second wrist joint is connected to the first wrist joint to form the wrist's second revolute joint; the axis of the wrist's first revolute joint is perpendicular to the plane defined by the axis of the second revolute joint of actuated limbs and the axis of the fourth revolute joint of actuated limbs ; and the axis of the wrist's second revolute joint is parallel to the plane.

6. The robot of claim 3, wherein the first prismatic joint, the second prismatic joint, and the third prismatic joint are actuated joints.
